(19) United States
(12) Patent Application Publication
(10) Pub. No.: US 2016/0003783 A1
(43) Pub. Date: Jan. 7, 2016

(54) ULTRASONIC INSPECTION DEVICE AND ULTRASONIC INSPECTION METHOD

(71) Applicant: YAMAHA FINE TECHNOLOGIES CO., LTD., Hamamatsu-shi, Shizuoka (JP)

(72) Inventors: Akihiro NARA, Hamamatsu-shi (JP); Yukitoshi SUZUKI, Iwata-shi (JP); Hidemi TAKAHASHI, Hamamatsu-shi (JP)

(21) Appl. No.: 14/760,713

(22) PCT Filed: Jan. 14, 2014
(86) PCT No.: PCT/JP2014/050460

§ 371 Date: Sep. 22, 2015

(30) Foreign Application Priority Data
Jan. 16, 2013 (JP) 2013-005779

(51) Int. Cl. G01N 29/24

(52) U.S. Cl. CPC G01N 29/2437; G01N 2291/102; G01N 2291/0289

(57) ABSTRACT

An ultrasonic inspection device includes a signal generator configured to generate a square wave burst signal, an ultrasonic wave transmitter configured to drive a probe according to the square wave burst signal output from the signal generator and transmit ultrasonic waves toward an inspection subject, an ultrasonic wave receiver configured to receive the ultrasonic waves transmitted toward the inspection subject and propagated through the inspection subject, and a defect determinator configured to determine the presence or absence of a defect in the inspection subject based on a signal from the ultrasonic wave receiver, wherein the square wave burst signal has square waves that continuously alternate due to positive voltages and negative voltages relative to a ground.

### TECHNICAL FIELD

The present invention relates to an ultrasonic inspection device and an ultrasonic inspection method, and more particularly, to an ultrasonic inspection device and an ultrasonic inspection method that are capable of propagating ultrasonic waves into an inspection subject even when a probe is spaced apart from a surface of the inspection subject, and inspecting a defect in the inspection subject.

Priority is claimed on Japanese Patent Application No. 2013-5779, filed Jan. 16, 2013, the content of which is incorporated herein by reference.

### BACKGROUND ART

In general, an ultrasonic inspection device is a device configured to inspect the presence or absence of a defect in an inspection subject by transmitting ultrasonic waves in a state in which a probe comes in contact with a surface of the inspection subject and receiving the ultrasonic waves propagated in the inspection subject, when the probe comes in communication with the inspection subject with no gap, water, oil, or the like, interposed therebetween. For this reason, a surface state of the inspection subject that can be inspected is limited, and when the inspection subject has a high temperature or is moved, water, oil, or the like, is not interposed between the probe and the inspection subject.

Here, even when the water, oil, or the like, cannot be disposed therebetween, a device that is able to inspect ultrasonic waves has been developed.

For example, an ultrasonic inspection device disclosed in Patent Document 1 determines the presence or absence of a defect of an inspection subject based on a level of a transmission wave signal by applying a square wave burst signal constituted by a predetermined number of continuous negative square waves to a probe and converting the ultrasonic waves propagated through the inspection subject into the transmission wave signal using the probe, and verifies a flaw detection result by displaying a signal after the frequency conversion of the transmission wave signal on a display together with a burst signal or the like. As the square wave burst signal constituted by the predetermined number of continuous negative square waves is used as a pulse signal applied to the probe, high conversion efficiency to ultrasonic waves of electrical signals is realized, and the level of the output ultrasonic waves is increased to enable air propagation.

### PRIOR ART DOCUMENT

### Patent Document

Patent Document 1

Japanese Unexamined Patent Application, First Publication No. 2008-128965

### SUMMARY OF INVENTION

### Problems to be Solved by the Invention

However, since the ultrasonic inspection device disclosed in Patent Document 1 is a device configured to apply only a negative square burst signal, the ultrasonic waves output from the probe are reduced, and thus, an S/N ratio is also reduced and inspection precision is decreased. In addition, since the S/N ratio is small, frequency conversion is needed and signal processing is complicated. Accordingly, a time consumed for inspection is also increased. In addition, as a high voltage is applied to a vibration element to increase the output ultrasonic waves, the lifetime of the vibration element may be reduced.

That is, like the ultrasonic inspection device disclosed in Patent Document 1, when a negative square burst wave is applied, for example, when a rated ultrasonic wave vibration element of ±400 V is to be driven, while driving methods from 0 V to −400 V are provided, efficiency is degraded because a voltage is not applied to the positive side. In addition, in these driving methods, when −400 V is applied to deform the element and then becomes 0 V, since the element is returned by elasticity thereof to its original state, transmission efficiency is degraded. Further, since the efficiency completely depends on the Young's modulus of the element, a driving state may be largely varied due to a variation of the element or a variation in temperature. In order to overcome these problems, while a method of realizing a positive/negative square wave by applying offset to a negative square wave is considered, since an offset voltage is always applied to the element in this way, the lifetime of the element may be decreased.

In consideration of the above-mentioned circumstances, the present invention is directed to provide an ultrasonic inspection device and an ultrasonic inspection method that are capable of transmitting ultrasonic waves in the air to perform an inspection of the inside of an inspection subject, simplifying signal processing at this time, and reducing a load to an ultrasonic wave vibration element, thereby increasing the lifetime of an element.

### Mean for Solving the Problems

In order to achieve the aforementioned objects, an ultrasonic inspection device of the present invention includes a signal generator configured to generate a square wave burst signal; an ultrasonic wave transmitter configured to drive a probe according to the square wave burst signal output from the signal generator and transmit ultrasonic waves toward an inspection subject; an ultrasonic wave receiver configured to receive the ultrasonic waves transmitted toward the inspection subject and propagated through the inspection subject; and a defect determinator configured to determine presence of a defect in the inspection subject based on a signal from the ultrasonic wave receiver, wherein the square wave burst signal has square waves that continuously alternate due to positive voltages and negative voltages relative to a ground.

As the positive and negative square wave burst signals relative to the ground are applied, the output ultrasonic waves can be increased compared to when only the negative or positive square wave burst signal is applied, and for this reason, the ultrasonic waves can be transmitted in the air to perform an inspection of the inside of the inspection subject, the S/N ratio is also increased, and the inspection precision is improved. Then, as the S/N ratio is improved, frequency conversion is not needed, signal processing can be simplified, and inspection time can be reduced.

In addition, when the device is driven by the square wave burst signal according to the negative voltage as disclosed in Patent Document 1 and the voltage becomes 0 V after the ultrasonic wave vibration element is deformed, the vibration element is returned to its original state by elasticity thereof. However, when the device is driven by the square wave burst signal in which the positive voltage and the negative voltage are continuous relative to the ground, since an external force by the positive or negative voltage is always applied, a bad influence to a transmission state due to a variation or heat generation of the vibration element can be reduced.

Further, even in the case in which the device is driven with the same amplitude as the ultrasonic waves when driven by only the negative or positive square wave burst signal, the load applied to the vibration element can be reduce to half, and the lifetime of the vibration element can be increased.

An ultrasonic inspection method of the present invention includes disposing probes to oppose each other and to be spaced a gap from a surface of an inspection subject; applying a square wave burst signal in which square waves continuously alternate due to positive voltages and negative voltages relative to a ground to drive the probes and transmit ultrasonic waves; receiving the ultrasonic waves propagating through the inside of the inspection subject; and determining a presence or absence of a defect in the inspection subject based on the received signal.

According to the ultrasonic inspection method of the present invention, since the positive and negative square wave burst signals relative to the ground are applied to generate the ultrasonic waves, the ultrasonic waves can be transmitted with a high output in the air having small acoustic impedance, and precision of the inspection of the ultrasonic wave in the air can be increased.

### Advantageous Effects of Invention

According to the present invention, the ultrasonic waves can be transmitted to the air to perform an inspection of the inside of the inspection subject, signal processing at this time can be simplified, and a load to the ultrasonic wave vibration element can be reduced, thereby increasing the lifespan of the vibration element.

### BRIEF DESCRIPTION OF DRAWINGS

FIG. 1 is a block diagram showing an ultrasonic inspection device according to an embodiment of the present invention.

FIG. 2 is a block diagram showing a signal generator of the embodiment.

FIG. 3 is a graph showing a square wave burst signal generated by the signal generator of the embodiment.

### EMBODIMENTS FOR CARRYING OUT THE INVENTION

Hereinafter, an embodiment of the present invention will be described with reference to the accompanying drawings.

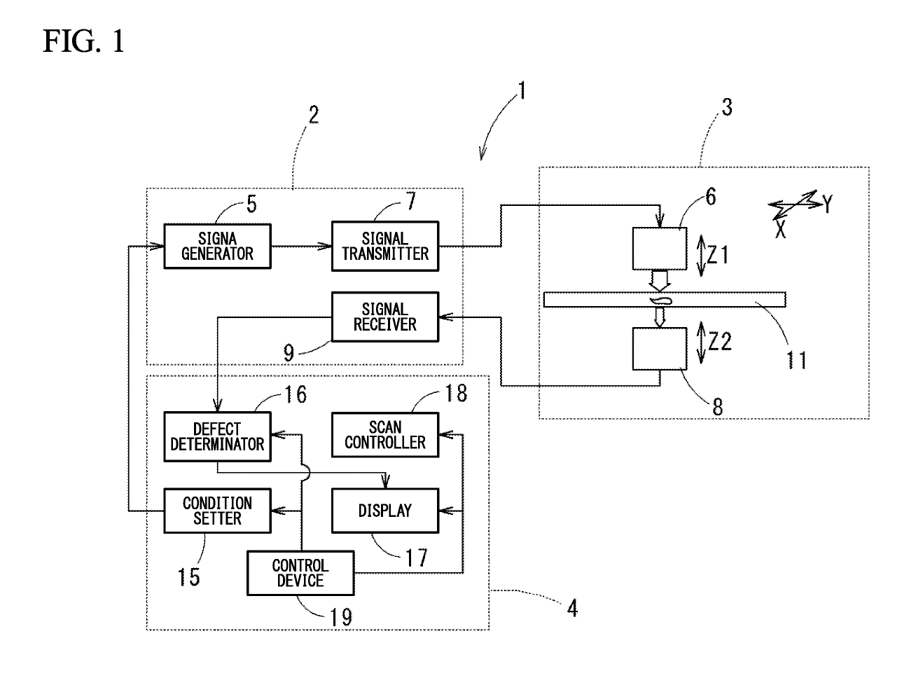

As shown in FIG. 1, an ultrasonic inspection device 1 of the embodiment is constituted by a pulser receiver 2, an exploration unit 3 and a signal processor 4.

The pulser receiver 2 has a signal generator 5 configured to generate an ultrasonic wave driving signal, a signal transmitter 7 configured to transmit the generated ultrasonic wave driving signal to a transmission probe 6, and a signal receiver 9 configured to receive a signal from a reception probe 8.

The exploration unit 3 has the transmission probe 6 configured to transmit ultrasonic waves toward an inspection subject 11 by an ultrasonic wave driving signal sent from the signal transmitter 7, and the reception probe 8 configured to receive the ultrasonic waves propagated to the inspection subject 11 and send the ultrasonic waves to the signal receiver 9 as a received voltage signal. The transmission probe 6 and the reception probe 8 each has an ultrasonic wave vibration element (not shown) constituted by a piezoelectric element disposed therein. In the transmission probe 6, ultrasonic waves are transmitted from the vibration element according to an input voltage signal, and in the reception probe 8, the received ultrasonic waves are converted into a voltage signal by a vibrator to be output.

Both of the probes 6 and 8 are opposite to each other via the inspection subject 11 by a scan mechanism unit (not shown), and are disposed in a state in which vibrators installed at the front end surfaces of the probes 6 and 8 face the inspection subject 11. Then, as the probes 6 and 8 are driven by the scan mechanism unit, both of the probes 6 and 8 can move in an X direction and a Y direction along a surface of the inspection subject 11, or a Z1 direction or a Z2 direction that goes away from or approaches the inspection subject 11, respectively.

The signal processor 4 includes a condition setter 15 configured to set a condition to generate an ultrasonic wave driving signal in the signal generator 5, a defect determinator 16 configured to determine the presence or absence of a defect in the inspection subject 11 based on the received voltage signal from the signal receiver 9, a display 17 configured to display the received voltage signal or the like, a scan controller 18 configured to control scan manipulations of the probes 6 and 8, and a control device 19 configured to input various control values into the condition setter 15, the defect determinator 16, the display 17 and the scan controller 18.

The signal processor 4 is constituted by a personal computer, a touch panel type control device 19 is installed on a screen of the display (monitor) 17, and various conditions or a control value such as positional information or the like with respect to the scan controller 18 can be set by the control device 19. Of course, a control device such as a keyboard or the like may be provided.

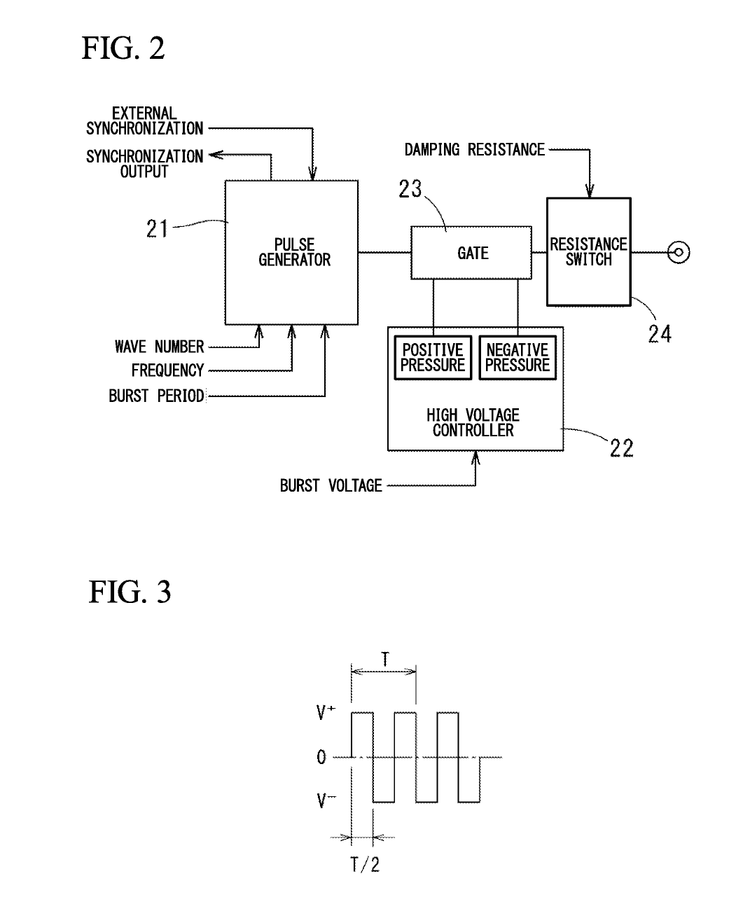

Referring to FIG. 2, the signal generator 5 has a pulse generator 21 configured to generate a continuous pulse signal for a specified period, a high voltage generator 22 configured to generate positive and negative voltages equal to a burst voltage set by the condition setter 15, a gate 23 configured to output the burst signal while switching the positive and negative voltages according to the pulse signal from the pulse generator 21, and a resistance switch 24 configured to control a square wave of the burst signal.

The condition setter 15 of the signal processor 4 sets signal generating conditions such as a wave number, frequency, a burst period and a burst voltage of the square wave burst signal, a damping resistance of the resistance switch, or the like, and sends them to the signal generator 5 while sending a synchronization signal at a predetermined timing from a clock generating circuit or the like (not shown) based on the control value input via the control device 19.

The pulse generator 21 of the signal generator 5 generates a pulse signal constituted by ON/OFF of the specified period while synchronizing an external synchronization signal based on the set signal of the wave number, the frequency and the burst period of the square wave burst signal set by the condition setter 15. In the gate 23, with respect to positive and negative direct current voltages generated by the high voltage generator 22, for example, as the positive voltage and the negative voltage are connected while being alternately switched such that the positive voltage is in a connection state when the pulse signal is ON and the negative voltage is in a connection state when the pulse signal is OFF, the positive and negative voltages are output as burst signals that continuously alternate. In the resistance switch 24, the positive and negative voltages are set to a desired resistance based on a damping resistance value set by the condition setter 15, and controlled to control overshoot or undershoot of a rising or falling portion of the square wave of the burst signal sent from the gate 23 to be output as the square wave burst signal with no disturbance.

In performing the ultrasonic wave inspection of the inspection subject 11 by the ultrasonic inspection device 1 configured as described above, when various set values are input from the control device 19 according to the inspection subject 11, the square wave burst signal in which the positive and negative voltages are continuous in a predetermined magnitude (for example, ±400 V) relative to the ground is generated by the signal generator 5, the square wave burst signal is applied to the transmission probe 6 via the signal transmitter 7, and the vibrator of the probe 6 is driven to transmit the ultrasonic waves to the inspection subject 11. The reception probe 8 is in standby at an opposite surface side of the inspection subject 11 to oppose the transmission probe 6 by the scan mechanism unit, the reception probe 8 receives the ultrasonic waves passing through the inspection subject 11 and converts the ultrasonic waves into a voltage signal, and the voltage signal is amplified by the signal receiver 9 to be sent to the defect determinator 16.

In the defect determinator 16, by comparing the received voltage signal with a preset threshold value, it is determined that there is a defect section when the received voltage signal is smaller than the threshold value. In addition, for example, it is possible to detect a variation in the received signal at continuous scan points and perform the defect determination from the slope of the variation. A determination result by the defect determinator 16 is related to the scan positional information to be displayed on the display 17, and in the display 17, displayed in a form such as a color-coded 2D image or the like, for example, according to the magnitude of the signal.

In the embodiment, as shown in FIG. 3, the square wave burst signal output from the signal generator 5 has a positive voltage and a negative voltage having symmetrical magnitudes relative to the ground and continuously alternate in a predetermined period T, and has energy corresponding to an area of the square. Then, as the square wave is formed in a shape in which positive and negative values are symmetrical, the output has a large energy obtained as a sum of an area formed of a positive voltage (V⁺)×a width (T/2) of the square and an area formed of a negative voltage (V⁻)×a width (T/2) of the square.

Accordingly, as the transmission probe 6 is driven according to the square wave burst signal, the ultrasonic waves having an extremely high level can be transmitted from the probe 6. For this reason, as shown in FIG. 1, even in a state in which both of the probes 6 and 8 are spaced apart from the surface of the inspection subject 11, the ultrasonic waves can be transmitted in the air from the vibrator of the transmission probe 6 to pass through the surface of the inspection subject 11 via the air, thereby propagating the ultrasonic waves to the inside of the inspection subject 11.

Since the transmission probe 6 can transmit the high level ultrasonic waves, the S/N ratio is also increased and the inspection precision is improved. In Patent Document 1, while the transmission wave signal received by the receiver is frequency-converted and displayed, in the present invention, as the S/N ratio is improved, frequency conversion as disclosed in Patent Document 1 is not needed, and thus, to that extent, the signal processing is simplified and inspection time can be reduced.

The ultrasonic inspection device 1 can inspect the inspection subject with no influence on a shape, disposition, or the like, of the inspection subject because the inspection precision is increased by the transmission of the high level ultrasonic waves, and for example, can be widely applied to defect inspection of laminated products used in a field such as industrial goods, food, medical products, or the like, internal defect inspection of various materials, inspection of an exfoliated section of a multi-layered laminated member, pinhole inspection, or the like.

Hereinabove, while the embodiments of the present invention have been described, the present invention is not limited to these embodiments but various modifications may be made without departing from claims of the present invention.

In the embodiment, while only the ultrasonic wave inspection by a penetration method of passing the ultrasonic waves transmitted from one surface side of the inspection subject through the inside of the inspection subject and receiving the ultrasonic waves at an opposite surface side is shown, the present invention can also be applied to the ultrasonic wave inspection by a reflection method of performing transmission and reception of the ultrasonic waves at only one surface side of the inspection subject. In addition, while the inspection subject is inspected by the two probes of the transmission probe and the reception probe, in the case of the reflection method, transmission and reception may be performed by one probe.

Further, in the embodiment, while two functions of the ultrasonic wave transmitter configured to transmit ultrasonic waves and the ultrasonic wave receiver configured to receive the ultrasonic waves are separately described, a configuration in which these two functions are performed by one instrument (probe) may also fall within the spirit of the present invention.

### INDUSTRIAL APPLICABILITY

In a state in which the probe comes in contact with the surface of the inspection subject, and of course, in a state in which the probe is spaced apart from the surface of the inspection subject, the present invention can be applied to an ultrasonic inspection device configured to inspect a defect in the inspection subject, the signal processing of the ultrasonic inspection device can be simplified, and a load to the ultrasonic wave vibration element can be reduced to increase the lifespan of the vibration element.

### DESCRIPTION OF REFERENCE SYMBOLS

1 ultrasonic wave flaw detection device

2 pulser receiver

3 exploration unit

4 signal processor

5 signal generator

6 transmission probe (ultrasonic wave transmitter)

7 signal transmitter

8 reception probe (ultrasonic wave receiver)

9 signal receiver

11 inspection subject

15 condition setter

16 defect determinator

17 display

18 scan controller

19 control device

21 pulse generator

22 high voltage generator

23 gate

24 resistance switch

1. An ultrasonic inspection device comprising:
a signal generator configured to generate a square wave burst signal;
an ultrasonic wave transmitter configured to drive a probe according to the square wave burst signal output from the signal generator and transmit ultrasonic waves toward an inspection subject;
an ultrasonic wave receiver configured to receive the ultrasonic waves transmitted toward the inspection subject and propagated through the inspection subject; and
a defect determinator configured to determine a presence or absence of a defect in the inspection subject based on a signal from the ultrasonic wave receiver,
wherein the square wave burst signal has square waves that continuously alternate due to positive voltages and negative voltages relative to a ground.

2. The ultrasonic inspection device according to claim 1, wherein the signal generator includes a pulse generator configured to generate pulse signals which are continuous in a designated period, a high voltage generator configured to generate a positive voltage and a negative voltage equal to a burst voltage of the square wave burst signal, a gate configured to alternately switch the positive and negative voltages to output the square wave burst signal according to the pulse signal from the pulse generator, and a resistance switch configured to control a shape of the square wave of the square wave burst signal.

3. The ultrasonic inspection device according to claim 2, including a condition setter configured to set at least one of a wave number, a frequency and a burst period of the square wave burst signal to the pulse generator.

4. The ultrasonic inspection device according to claim 2, including a condition setter configured to set the burst voltage of the square wave burst signal to the high voltage generator.

5. The ultrasonic inspection device according to claim 2, including a condition setter configured to set a damping resistance value which controls a shape of the square wave of the square wave burst signal to the resistance switch.

6. An ultrasonic inspection method comprising:
disposing probes to oppose each other and to be spaced apart from a surface of an inspection subject;
applying a square wave burst signal in which square waves continuously alternate due to positive voltages and negative voltages relative to a ground to drive the probes and transmit ultrasonic waves;
receiving the ultrasonic waves propagating through the inside of the inspection subject; and
determining a presence or absence of a defect in the inspection subject based on the received signal.
